(19) United States
(12) Patent Application Publication
(10) Pub. No.: US 2026/0132056 A1
(43) Pub. Date: May 14, 2026

(54) UV WATER PURIFICATION SYSTEM AND METHODS

(71) Applicant: The Regents of the University of California, Oakland, CA (US)

(72) Inventors: Haizhou LIU, Riverside, CA (US); Gongde CHEN, Riverside, CA (US)

(73) Assignee: The Regents of the University of California, Oakland, CA (US)

(21) Appl. No.: 18/868,551

(22) PCT Filed: Feb. 14, 2023
(86) PCT No.: PCT/US2023/013054

§ 371 Date: Nov. 22, 2024

Related U.S. Application Data
(60) Provisional application No. 63/345,784, filed on May 25, 2022.

(51) Int. Cl. C02F 1/32; C02F 1/66; C02F 1/70; C02F 101/36

(52) U.S. Cl. CPC C02F 1/32; C02F 1/66; C02F 1/70; C02F 2101/36; C02F 2209/06

(57) ABSTRACT

The invention provides a method for removing contaminants from an aqueous solution using ultraviolet light having a wavelength of 230 nm or less under reductive conditions.

### CROSS-REFERENCE TO RELATED APPLICATION

This application claims priority to U.S. Provisional Application No. 63/345,784 filed on May 25, 2022. The entire content of the application referenced above is hereby incorporated by reference herein.

### STATEMENT REGARDING FEDERALLY SPONSORED RESEARCH

This invention was made with government support under 2131745 awarded by the National Science Foundation. The government has certain rights in the invention.

### BACKGROUND

Per- and poly-fluoroalkyl substances (i.e., PFAS) have been widely found in terrestrial, aquatic, and atmospheric environments due to their wide application in manufacturing, fire-fighting practices, food packaging, and commercial household products and improper disposal. Long-term exposure to PFAS-contaminated environments has led to ubiquitous detection of PFAS in human serum, which is posing great threat on public health. US EPA has issued a life-time health advisories for perfluorooctanoic acid (PFOA) at 0.004 parts per trillion (ppt) and for perfluorooctane sulfonic acid (PFOS) at 0.02 ppt in drinking water, and a national primary drinking water standard for PFOA and PFOS is expected to be issued soon. EPA is proposing to designate PFOA and PFOS as hazardous substances under the Comprehensive Environmental Response, Compensation, and Liability (CERCLA). State agencies have proposed varied regulatory and notification levels for PFAS compounds in drinking water. For instance, New Jersey has established a maximum contaminant level (MCL) for PFOS and perfluorononanoic acid (PFNA) at 13 ppt and a MCL for PFOA at 14 ppt. Massachusetts has established a MCL at 20 ppt for the sum of 6 PFAS compounds including PFOA, PFOS, perfluorohexanesulfonic acid (PFHxS), PFNA, perfluoroheptanoic acid (PFHpA), and perfluorodecanoic acid (PFDA). The newly established US EPA 5^{th} Edition Unregulated Contaminant Monitoring Rule (UCMR 5) requires the monitoring of 29 PFAS compounds in public drinking water systems.

The regulatory actions taken on PFAS at federal and state levels strongly drive technological development for PFAS treatment under different environmental settings. Commonly used physical treatment technologies, including activated carbon adsorption, ion exchange, and membrane separation (i.e., nanofiltration and reverse osmosis), are based on phase partitioning to separate PFAS from source water to solid or liquid media. Therefore, a secondary waste stream concentrated with PFAS is generated and needs destructive treatment prior to discharge. Until now, there lacks an efficient and sustainable technology for complete destruction of PFAS. The conventional destructive technologies using chemical reagents and microorganisms are not effective to degrade PFAS, because of their limited capabilities in breaking C—F bonds in fluoroalkyl chain. Although high-temperature incineration can destroy PFAS compounds, it suffers from intensive energy consumption and high operational cost.

Reductive treatment using highly reducing species is one of the most effective approaches to break C—F bonds and destroy PFAS compounds. Hydrated electrons (i.e.,

$${e}_{aq}^{-} )$$

are very effective to degrade PFAS, because they have a very negative reduction potential (E°=−2.9 V) and a high reactivity with C—F bonds. Hydrated electrons can be generated by a variety of approaches, including UV photolysis of ionizable chemicals (e.g., sulfite, iodide, etc.) and water dissociation by radiolysis, sonolysis, plasma, and electron beams. These processes, however, have various drawbacks. For instance, UV photolysis of ionizable chemicals suffers from low quantum yield of hydrated electrons (φ=0.11-0.29), a high chemical dosage (mM levels), and the formation of unwanted by-products that requires additional purification. Water dissociation by radiolysis, sonolysis, plasma, and electron beams requires high energy input, expensive and undeployable ionization instrumentation, or complex operations and maintenance for real applications.

Vacuum UV light (VUV)-driven water photolysis provides a promising photochemical platform for the treatment of PFAS. Compared with conventional UV light between 245 and 400 nm, VUV light specifically refers to wavelength range between 100 and 200 nm. Far UVC light specifically refers to wavelength range between 200 and 220 nm. The energetic UV photons (λ≤220 nm) are strongly absorbed by water molecules, and photolyzed water into a mixture of both oxidizing and reducing reactive species including hydroxyl radical (HO·), hydrogen atom (H·), and

$${e}_{aq}^{-} .$$

In addition, common water anions, including hydroxide anions, chloride, and sulfate can be photolyzed into hydrated electrons and the corresponding oxidizing radical counterpart (e.g., HO·, Cl·, and SO⁴·⁻) by UV light (λ≤220 nm). However, conventional VUV and far UVC water photolysis has a very low quantum yield of hydrated electrons (φ=0.045). In addition, the generated hydrated electrons are readily scavenged by common water constituents (e.g., O₂ and H⁺), which further reduces the availability of hydrated electrons for PFAS treatment. Furthermore, the coexistence of oxidizing HO· and reducing H· and

$${e}_{aq}^{-}$$

significantly compromised the reducing polarity of VUV photochemical systems. Early studies demonstrated that VUV water photolysis system could reductively degrade PFAS compounds (X. Liang, et al., Chem. Eng. J., 2016, 298, 291-299; L. Jin, P. Zhang, Chem. Eng. J., 2015, 280, 241-247; Y. Wang, P. Zhang, Journal ofEnvironmental Sciences, 2014, 26, 2207-2214; M. Cao et al., J. Hazard. Mater, 2010, 179, 1143-1146; J. Chen, P.-Y. Zhang, J. Liu, Journal ofEnvironmental Sciences, 2007, 19, 387-390; and J. Chen, P. Zhang, Water Sci. Technol., 2006, 54, 317-325), however, the treatment efficiency was very low. The limited efficiency of conventional VUV photochemical systems for PFAS treatment is likely due to low yield of hydrated electrons and low polarized reducing environments.

Currently there is a need for improved methods for removing contaminants from water (e.g., drinking water, industrial waste, and hazardous waste). In particular, there is a need for methods that can be effectively and economically carried out on a commercial scale. A more effective and energy efficient method is needed.

### SUMMARY

To overcome the deficiency of conventional UV photochemical system, a tuning strategy for UV water photolysis system was developed to increase the yield of hydrated electrons and increase the reducing polarity by minimizing the scavenging effects and converting unwanted reactive species to hydrated electrons. It was found that the speciation and abundance of reactive radicals can be chemically modulated by environmentally sustainable solutes to create a highly polarized reducing environment that can significantly enhanced the degradation of contaminants (e.g., the defluorination of PFAS compounds). Specifically, environmentally sustainable tunable chemicals (e.g., N₂, H₂, alcohols or carboxylic acids) can stabilize hydrated electrons or transform HO· into highly reducing species (e.g., H· and

$${e}_{aq}^{-} . )$$

and themselves are converted to environmentally benign products (e.g., H₂O). Furthermore, water chemistry parameters (e.g., pH) can be tuned to change the speciation and abundance of the reactive species. For instance, increasing the pH value of reaction solution can convert H· into

$${e}_{aq}^{-}$$

(pK=9.7), which can further increase the yield of the hydrated electrons. Lastly, common water constituents (e.g., chloride and sulfate) can be beneficially used by UV light because these anions can strongly absorb UV light (λ≤220 nm) and directly photolyze into hydrated electrons.

A tunable, sustainable, and highly effective UV photochemical systems has been developed to destroy contaminants (e.g., PFAS) by selective generation of hydrated electrons from water, while not generating secondary byproducts that need further treatment. Hydrogen gas (H₂) was selected as the tunable chemical for UV photochemical systems given its capability to transform HO· into

$${e}_{aq}^{-}$$

and its clean product (i.e., H₂O) after the reaction. Additionally, the photochemical system is advantageous with respect to energy efficiency. Its energy consumption is much smaller than other existing PFAS destruction technologies.

PFOA and PFOS were selected as model PFAS compounds. PFOA and PFOS are the first two PFAS that are expected to be regulated by US EPA. They are two of the most stable PFAS compounds and are common end products from degradation of other PFAS precursor compounds. The impact of H₂ and water chemistry parameters (e.g., solution pH and coexisting constituents) on the degradation and defluorination of PFOA and PFOS was investigated. The degradation products of PFOA and PFOS using LC-HRMS/MS were monitored.

Accordingly, in one embodiment, the invention provides a method comprising, treating an aqueous solution that comprises a contaminant with ultraviolet light having a wavelength of 220 nm or less under reductive conditions to eliminate at least 75% of the contaminant from the solution.

In another embodiment, the invention provides a method which comprises:
providing an aqueous solution that comprises a contaminant;
conditioning the aqueous solution with the addition of a tunable chemical;
optionally adjusting the pH of the tuned solution so that it is between about 7 and about 12; and
irradiating the tuned solution with UV light having a wavelength between about 100 nm and about 230 nm until at least 75% of the contaminant is eliminated from the solution.

In another embodiment, the invention provides a method which comprises:
providing an aqueous solution that comprises a contaminant.
sparging the aqueous solution with H₂ gas to provide a sparged solution;
optionally adjusting the pH of the sparged solution so that it is between about 7 and about 12;
irradiating the sparged solution with UV light having a wavelength between about 100 nm and about 230 nm until at least 75% of the contaminant is eliminated from the solution.

In another embodiment, the invention provides a method which comprises:
providing an aqueous solution that comprises a contaminant;
conditioning the aqueous solution with the addition of a tunable chemical;
optionally adjusting the pH of the tuned solution so that it is between about 7 and about 12; and
irradiating the tuned solution with UV light having a wavelength between about 100 nm and about 220 nm until at least 75% of the contaminant is eliminated from the solution.

In another embodiment, the invention provides a method which comprises:
providing an aqueous solution that comprises a contaminant.
sparging the aqueous solution with H₂ gas to provide a sparged solution;
optionally adjusting the pH of the sparged solution so that it is between about 7 and about 12;
irradiating the sparged solution with UV light having a wavelength between about 100 nm and about 220 nm until at least 75% of the contaminant is eliminated from the solution.

In another embodiment, the invention provides a method comprising: irradiating an aqueous solution including a contaminant with vacuum ultraviolet radiation; and bubbling a gas through the aqueous solution.

In another embodiment, the invention provides an apparatus comprising: a vessel to hold an aqueous solution including a contaminant that includes fluorine-carbon bonds; and a high vacuum ultraviolet transmittance quartz sleeve housing and electromagnetic radiation; and a mechanical device component to introduce the tunable chemical into the vessel.

### BRIEF DESCRIPTION OF THE DRAWINGS

FIG. 1. Shows defluorination of PFOA in various gas-saturated solution environments under the irradiation of UV light (λ≤220 nm) and traditional UV light (λ=254 nm). Solution conditions: [PFOA]=25 μM, pH=12, the solution was sparged with the selected gas for 30 minutes before the reaction and was continuously bubbled with the gas during the reaction.

FIG. 2. Shows the impact of coexisting constituents on defluorination of PFOA in a H₂-saturated UV photochemical system (λ≤220 nm). Solution conditions: [PFOA]=25 μM, pH=12, and [other constituents]=5 mM or 5.4 mg-C/L. The solution was sparged with H₂ for 30 minutes before the reaction and was continuously bubbled with H₂ during the reaction.

FIGS. 3A-3B. Shows the impact of pH on (FIG. 3A) defluorination and (FIG. 3B) degradation of PFOA in a H₂-saturated UV photochemical system (λ≤220 nm). Solution conditions: [PFOA]=2.5 μM, and initial pH=7-12.

FIG. 4. Shows degradation of trace levels of PFOA and PFOS in tap water by a H₂-tuned UV photochemical system (λ≤220 nm). The tap water collected from the city of Riverside CA and spiked with PFOA or PFOS. Tap water conditions: [PFOA]=1300 ng/L, [PFOA]=580 ng/L, and initial pH=8.0.

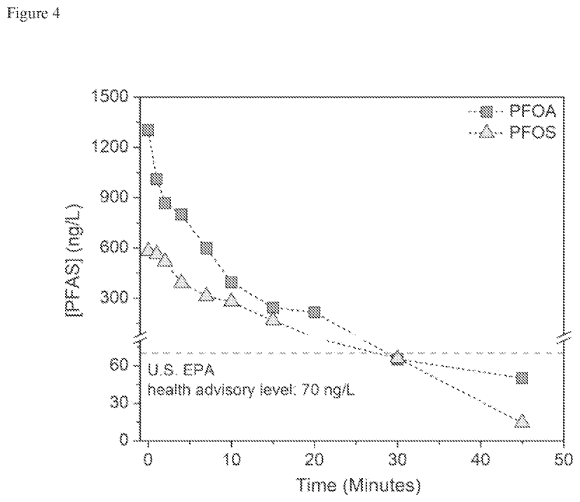

FIG. 5. Shows the impact of tuning chemicals on defluorination of PFOA in a UV photochemical system (λ≤220 nm). Solution conditions: [PFOA]=25 μM, pH=12, and the solution was dosed with 5 mM formate or bubbling with H₂ gas.

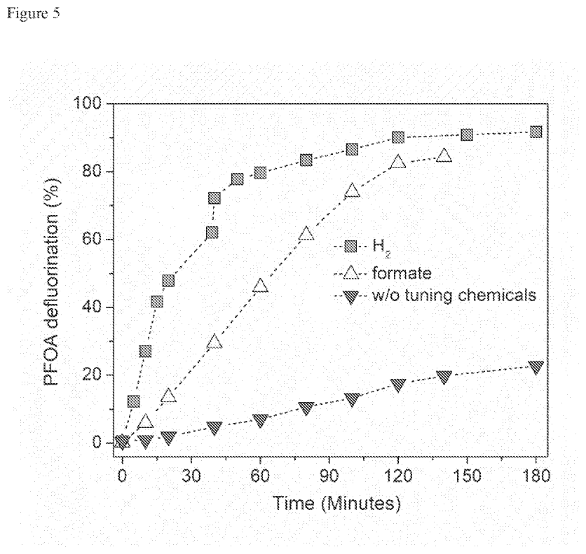

### DETAILED DESCRIPTION

As used herein, the term “contaminant” includes organic contaminants, metals, metalloids, oxyanions, fluorinated compounds, radionuclides, and microbial contaminants. Non-limiting examples of organic contaminants include chlorinated compounds (e.g., trichloroethylene), 1,4-dioxane, pesticides, nitro-aromatic compounds. Non-limiting examples of metals include hexavalent chromium and pentavalent vanadium. Non-limiting examples of metalloids include selenium and arsenic. Non-limiting examples of fluorinated compounds include fluoroalkyls and perfluoroalkyls (e.g., perfluoroalkyl carboxylates, perfluoroalkyl sulfonates, and fluorotelomers). Non-limiting examples of oxyanion compounds include nitrates, bromate, perchlorate, and chlorate. Non-limiting examples of radionuclide compounds include compounds that comprise uranium. Non-limiting examples of microbial contaminants include bacteria and viruses.

When a solution has a pH between about 7 and about 12, the pH can be at least about 7, at least about 8, at least about 9, at least about 10, or at least about 11. In one embodiment, when a solution has a pH between about 7 and about 12, the pH is at least about 9.

When a solution has a pH between about 2 and about 7, the pH can be less than about 6, less than about 5, less than about 4, or less than about 3. In one embodiment, when a solution has a pH between about 7 and about 12, the pH is at least about 9.

The term “aqueous solution” includes solutions that comprise water. In one embodiment the aqueous solution comprises at least about 25 weight percent water. In one embodiment the aqueous solution comprises at least about 50 weight percent water. In one embodiment the aqueous solution comprises at least about 75 weight percent water. In one embodiment the aqueous solution comprises at least about 90 weight percent water. In one embodiment the aqueous solution is water. Aqueous solutions include but are not limited to municipal wastewater, drinking water, industrial wastewater, stormwater, landfill leachate, and concentrated brine wastewater.

In one embodiment, at least 85% of the contaminant is eliminated from the aqueous solution. In one embodiment, at least 90% of the contaminant is eliminated from the aqueous solution. In one embodiment, at least 95% of the contaminant is eliminated from the aqueous solution.

As used herein, the term “eliminated from the aqueous solution” includes destruction of the contaminant and/or conversion of the contaminant to one or more entities that are less toxic than the contaminant.

As used herein, the term “tunable chemical” includes any substance that is capable of increasing the yield of hydrated electrons and/or minimizing scavenging effects electron donating solutes can offer electrons and selectively transform electron-deficient oxidizing reactive species (e.g., hydroxyl radical) into highly reducing species (e.g., hydrated electrons), eliminate the scavenging effects of common water constituents (e.g., dissolved oxygen), and consequently increase the reducing polarity of the reaction system for reductive treatment of environmental contaminants. In one embodiment, the tunable chemical is selected from the group consisting of gasses, alcohols and carboxylates. In one embodiment, the electron donating substance is selected from the group consisting of N₂ gas, H₂ gas, alcohols and carboxylic acids. In one embodiment, the tunable chemical is an environmentally sustainable tunable chemical.

As used herein, the term “reductive conditions” includes reaction environments containing hydrated electrons, hydrogen atom, or/and carbon-centered radicals (e.g., ·CO₂⁻) In one embodiment, the reductive conditions comprise hydrated electrons. In one embodiment the reductive conditions comprise a highly polarized reducing environment that is generated by environmentally sustainable tunable chemicals that transform HO· into highly reducing species (e.g., H· and

$${e}_{aq}^{-} . )$$

and are converted to environmentally benign products.

In one embodiment, the wavelength of light is between about 100 nm and about 230 nm.

In one embodiment, the wavelength of light is between about 100 nm and about 220 nm.

In one embodiment, the wavelength of light is between about 100 nm and about 200 nm.

As used herein, the term “drinking water” includes groundwater, surface water, recycled water and stormwater that can be used for human drinking purposes.

As used herein, the term “industrial waste” includes wastewater discharged from different manufacturing industries, and saline wastewater (e.g., ion exchange regenerant brine, reverse osmosis concentrate, and oil-gas produced water) generated from different industrial processes.

As used herein, the term “hazardous waste” includes aqueous waste containing hazardous levels of substances (e.g., organic contaminants, toxic heavy metals, metalloids, and radionuclides) that have been regulated or will be regulated soon.

The invention will now be illustrated by the following non-limiting Example.

### EXAMPLE

### Example 1

### Photochemical Experiments

Photochemical degradation and defluorination of PFOA and PFOS were performed in a cylindrical borosilicate glass reactor (Ace Glass, 7841-05) with a cooling jacket to maintain the temperature of the reaction solution. Three VUV lamps (14 W, GPH287T5VH/4) and one VUV lamp (10 W, GPH212T5VH/4) were packed together and served as light sources. The light source emitted a combination of 185-nm and 254-nm. The irradiance of VUV light at 185 nm was 8% relative to that of UVC light at 254 nm and was the active VUV wavelength investigated in this study. The lamp was housed in a high UV and VUV transmittance synthetic quartz sleeve (Suprasil 310, Heraeus) and they were immersed in 500 mL reaction solution. To minimize the attenuation of VUV light by O₂, high purity N₂ gas purged out of air in the quartz sleeve and was continuous flowing through the quartz sleeves during the reaction. The heat generated from the lamp was absorbed by the reaction solution that cooled down by tap water running through cooling jacket.

Typically, a 500-mL solution containing 25 μM of PFAS compound was sparged with H₂ for 30 minutes prior to irradiation. The solution pH was adjusted to a targeted level between 7 and 12. H₂ gas was continuously bubbled the gas through the solution during the reaction processes. Buffers were not used to maintain the solution pH, because they could potentially scavenge the reactive species in VUV photochemical systems. At a predetermined time, 6 mL of reaction solution was withdrawn from the reactor and transferred to a glass vial. To confirm the role of reactive species in VUV photochemical systems, control experiments were performed by sparging the solution using other selected gas, including N₂, air, or N₂O. A low initial concentration of 2.5 μM for PFOA was used to study the effect of pH on H₂-tuned VUV photochemical systems. This level of PFOA serves as an upper limit for highly contaminated groundwater near PFAS industrial discharge sites or some military sites with frequent fire-fighting practices and serves as a typical level of PFAS in industrial wastewater. To investigate the effect of coexisting constituents, a 25 μM PFOA solution saturated with H₂ at pH 12.0 was spiked with 5 mM chloride, 5 mM sulfate, 5 mM carbonate, or 5.4 mg-C/L Suwannee River humic acid. To evaluate the application potentials of VUV systems with H₂ purging for PFAS-impacted drinking water, trace 1300 ng/L PFOA or 580 ng/L PFOS were added into Riverside CA tap water and evaluated the destruction of the PFAS during the VUV treatment.

### Sample Analysis

The concentration of fluoride ions was measured by an ion selective electrode (ISE, Fisherbrand accumet solid-state) connected to a Thermo Scientific Orion Versa Star meter. Total ionic strength adjustment (TISAB) buffer was added to sample solution with equal volume to mask minor differences in ionic strength among samples and to buffer final pH values between 5 and 5.5. For sample solutions at pH 12.0 and above, TISAB buffer did not have sufficient buffer capacity to adjust the pH values of sample solution to the expected range. To eliminate the interference from hydroxide ions, a small volume of 1 M hydrochloric acid was added to neutralize the sample solution. The accuracy of fluoride ISE for F⁻ measurements was validated by ion chromatography. The defluorination percentage (DeF %) was calculated by eq. 1

$$DeF \% = \frac{[ {F}^{-} ]}{19 \times [ PFAS ] \text{?} \times {N}_{F}} \qquad ( 1 )$$

$$\text{?} \text{indicates text missing or illegible when filed}$$

where [F⁻] represents the mass concentration of fluoride ions measured by fluoride ISE (mg/L), [PFOA]₀ represents the initial molar concentration of PFAS compounds (mM), and NF represents the number of fluorine atom in PFAS compounds (i.e., 15 for PFOA; 17 for PFOS). PFAS compounds and their transformation products were analyzed by liquid chromatography equipped with a high-resolution quadrupole orbitrap mass spectrometer (LC-HRMS/MS) (Q Exactive, Thermo Fisher Scientific). For analyses of trace levels of PFOA and PFOS in tap water, we performed solid phase extraction using Oasis Wax cartridges (6 cc, 150 mg, and 30 μm) based on the U.S. EPA Method 537.1 to concentrate PFAS compounds by a factor of 50. The concentrate was analyzed using Waters ACQUITY UPLC™ system coupled with Waters Micromass triple quadrupole (TQD) mass spectrometer equipped with an electrospray ionization source (Milford, MA, USA).

### Results and Discussion

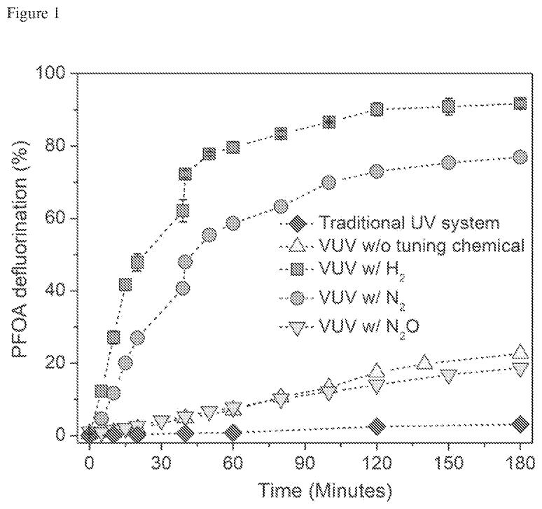

Breaking C—F bonds in PFAS alkyl chains is a key metric to assess the efficacy of a destructive technology for PFAS treatment. The defluorination of PFOA was investigated in a gas-saturated alkaline solution under the irradiation of VUV (λ=185 nm) and traditional UV light (λ=254 nm) (FIG. 1). There was a negligible defluorination (<4%) under the irradiation of traditional UV light at 254 nm. Similarly, there was a negligible defluorination (<20%) under the irradiation of VUV light at 185 nm when the VUV system was not tuned with chemical additives, which indicated that conventional VUV system was not effective in PFAS destruction. In contrast, when the VUV system was tuned with hydrogen gas, the defluorination percentages drastically increased from 23% to 92% at 180 minutes. VUV system tuned with nitrogen gas (N₂) also enhanced the defluorination of PFOA, but to a lesser extent (i.e., defluorination percentage increased from 23% to 77%). Adding nitrous oxide gas (N₂O) as a candidate tuning chemical into the VUV system was not effective.

The influence of sparging gases on defluorination of PFOA was due to their chemical tuning effect on the speciation and abundance of reactive species in aqueous phase. At pH 12, VUV photons photolyzed water molecules and hydroxide anions mainly into HO and

$${e}_{aq}^{-}$$

### (Reactions 2-4):

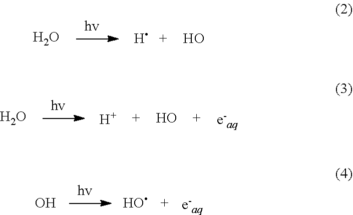

Prior studies have demonstrated that

$${e}_{aq}^{-}$$

was one of the most effective species to destroy PFAS, while HO· was ineffective. In conventional VUV system without a tuning chemical, dissolved oxygen quenched more than 99% of

$${e}_{aq}^{-}$$

(Reaction 5), given that its concentration and reaction rate constant with

$${e}_{aq}^{-}$$

were one order of magnitude higher than those of PFAS (i.e., 250 μM vs. 25 μM; 10¹⁰ M⁻¹s⁻¹ vs. 10⁹ M⁻¹s⁻¹):

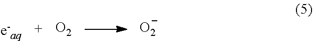

Such a strong scavenging effect significantly reduced the availability of

$${e}_{aq}^{-}$$

and led to inefficient defluorination in air-saturated solution. Sparging solution with N₂ gas removed dissolved oxygen, which dramatically increased the transient concentration of

$${e}_{aq}^{-}$$

and consequently increased the defluorination percentage. Saturating solution with the tuning chemical H₂ gas also eliminated the scavenging effect of dissolved oxygen on

$${e}_{aq}^{-} .$$

More importantly, H₂ transformed HO· into additional e_{aq}⁻ under alkaline conditions (Reaction 6):

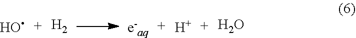

The tuning effect of H₂ on the speciation and abundance of reactive species in aqueous phase significantly increased the yield of

$${e}_{aq}^{-}$$

thus the defluorination percentage of PFOA. The major role of

$${e}_{aq}^{-}$$

on defluorination was further confirmed with a standard

$${e}_{aq}^{-}$$

quencher, N₂O (Solubility: 34 mM in water, Reaction 7, k=9.1×10⁹ M⁻¹ s⁻¹):

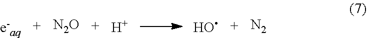

Replacing H₂ with N₂O decreased the defluorination percentage from 92% to 19%, which indicated that

$${e}_{aq}^{-}$$

mainly accounts for the cleavage of C—F bonds in PFOA. The minor defluorination under N₂O-saturated condition was likely due to the direct photolysis of PFOA by VUV light.

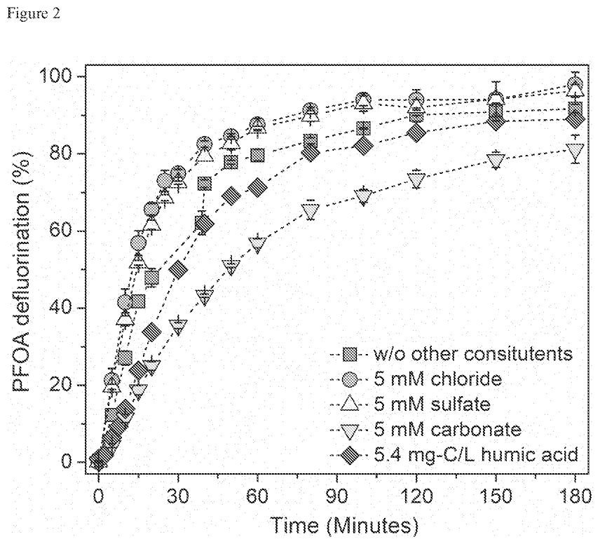

The real water matrix also contains other inorganic and organic constituents that can influence radical chemistry in VUV photochemical system and thus its performance for PFAS treatment. The effect of common water constituents on defluorination of PFOA in a H₂-tuned VUV photochemical system was examined. When the coexisting constituents were at levels relevant to groundwater matrices, the H₂-saturated VUV photochemical system exhibited the same or even higher defluorination efficiency for PFOA than in the absence of the coexisting constituents (FIG. 2). Specifically, the presence of chloride and sulfate anions promoted the defluorination by 4-6%, which led to nearly 100% defluorination after 180 minutes of reaction. Humic acid had no effect on defluorination. Although carbonate reduced defluorination percentage to a larger extent, more than 80% of defluorination was still achieved in the end.

The effects of anions and dissolved organic matter on defluorination of PFOA was due to their influence on the speciation and abundance of reactive species in H₂-saturated VUV photochemical systems. Chloride and sulfate anions can strongly absorb VUV light (ε_{cl}_{^{−}}_{0.185 nm}=3800 M⁻¹s⁻¹;

$${ε}_{{SO}_{4}^{z -} , 185 nm} = 260 {M}^{- 1} {s}^{- 1} )$$

and have high quantum yield for

$${e}_{aq}^{-}$$

(Ø_{cl}_{^{−}}_{0.185 nm}=0.43; Ø_{cl}_{^{−}}_{0.185 nm}=0.71). VUV photolysis of Cl⁻ and SO₄²⁻ anions generated additional e_{aq}⁻ (Reactions 8-9), which contributed to their promoting effects on defluorination of PFOA. Carbonate slightly reduce defluorination efficiency, mainly, because it had no effect on the production of primary

$${e}_{aq}^{-}$$

from VUV photolysis of H₂O and HO— and only reduced extra production of

$${e}_{aq}^{-}$$

from H₂ by scavenging HO·. The defluorination percentage in the presence of carbonate was comparable to that in the given N₂-saturated VUV photochemical system where no extra

$${e}_{aq}^{-}$$

was produced from HO·, confirming that the effect of carbonate on defluorination was due to its quenching on HO·.

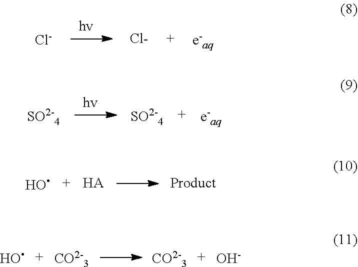

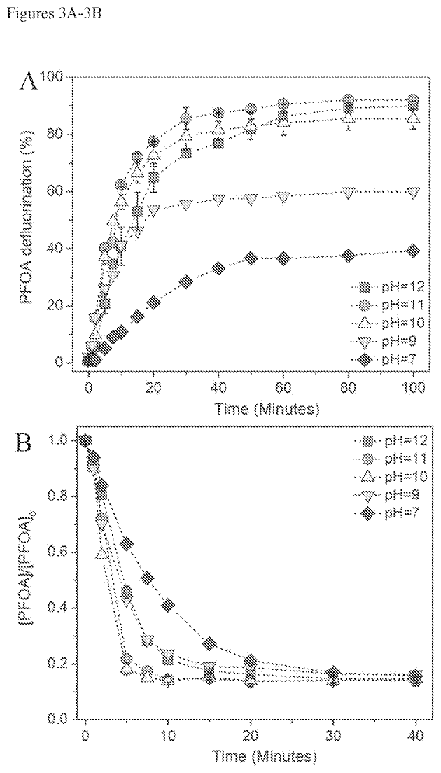

PFAS-contaminated water can be nearly neutral (e.g., groundwater) or highly alkaline (e.g., ion exchange regeneration brine). The influence of pH on the defluorination and degradation of PFOA in a H₂-tuned VUV photochemical system was investigated. The results showed that the solution pH affected the reactivity of the system, and alkaline condition favored PFAS destruction (FIG. 3). Specifically, when pH was greater than 9, more than 80% of defluorination was achieved within 60 minutes. The defluorination percentage dropped to 60% at pH 9 and 40% at pH 7. Although the degradation of PFOA slowed down at pH below 10, more than 85% of PFOA were removed within 40 minutes, regardless of solution pH. pH mainly influenced the speciation of

$${e}_{aq}^{-} .$$

The reported pK value for

$${e}_{aq}^{-}$$

is 9.7. As pH was below 9.7,

$${e}_{aq}^{-}$$

was protonated and H· became the dominant species. Early studies have shown that H was less effective for PFAS treatment. The decline in defluorination percentage and PFOA degradation rates can be explained by the conversion of

$${e}_{aq}^{-}$$

to H· reducing the availability of e_{aq}⁻ for PFOA treatment. At pH 7 and 9, defluorination was much less complete than degradation of PFOA mother compound (e.g., 40% defluorination vs 85% degradation at pH 7.0), mainly, because of the accumulation of recalcitrant defluorination intermediates and their resistance for further transformation.

The performance of the H₂-tuned VUV photochemical system was evaluated for the degradation of trace levels of PFAS in drinking water. The PFAS-impacted drinking water was simulated by spiking trace levels of PFOA and PFOA into tap water collected from the city of Riverside CA, in which typical water constituents (e.g., chloride, sulfate, bicarbonate, and nitrate) have concentrations more than 5 orders of magnitude higher than those of PFAS compounds. The concentration profiles showed that the H₂-tuned VUV photochemical system efficiently reduced the levels of PFOA and PFOS in tap water within a short period of reaction time. Specifically, after 30 minutes of irradiation, the concentration of PFOA drastically decreased from 1300 to 65 ng/L, and the concentration of PFOS significantly dropped from 580 ng/L to 66 ng/L. More than 95% of PFAS compounds was removed from tap water within 45 minutes.

### Implications

A tunable VUV photochemical system using hydrogen gas and a special reactor design to create a highly reducing environment for PFAS destruction was developed; its superior efficiency for PFOA removal under different water chemistry conditions was demonstrated. Additional studies found that the VUV photochemical system has superior performance for treatment of more recalcitrant PFAS compounds, i.e., PFOS as well. Compared with the benchmark UV/sulfite system, H₂-saturated VUV photochemical systems use clean H₂ instead of sulfite, which eliminates the introduction of sulfate into solution, and it can achieve higher defluorination and minimal formation of recalcitrant intermediates. Given that the irradiance of effective VUV light at 185 nm only accounts for 8% of UV irradiance at 254 nm, the VUV photochemical system is more energy efficient that UV/sulfite system. By applying a light source with high UV irradiance at VUV region, the treatment and energy efficiency of the newly developed system can be significantly improved. The VUV photochemical systems can be used as large throughput flow-through reaction systems for PFAS-impacted drinking water sources as well PFAS-laden concentrated waste streams generated from membrane separation and ion exchange processes.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1-6. (canceled)

7. A method of removing a contaminant from a solution, which comprises:
providing an aqueous solution that comprises a contaminant;
conditioning the aqueous solution with the addition of a tunable chemical selected from the group consisting of H₂, N₂, alcohols, and carboxylic acids;
optionally adjusting the pH of the tuned solution so that it is between about 7 and about 12; and
irradiating the tuned solution with UV light having a wavelength between about 100 nm and about 230 nm until at least 75% of the contaminant is eliminated from the solution.

8. The method of claim 1, wherein the contaminant is an organic contaminant, a metal, a metalloid, a nutrient, an oxyanion, a fluorinated compound, a radionuclide, or a microbial contaminant.

9. The method of claim 8, wherein the organic contaminant is a chlorinated compound, 1,4-dioxane, a pesticide, or a nitro-aromatic compound.

10. The method of claim 8, wherein the metal is hexavalent chromium or pentavalent vanadium.

11. The method of claim 8, wherein the metalloid is selenium or arsenic.

12. The method of claim 8, wherein the fluorinated compound is a perfluoroalkyl carboxylate, a perfluoroalkyl sulfonate, or a fluorotelomer.

13. The method of claim 8, wherein the oxyanion is a nitrate, bromate, perchlorate, or chlorate.

14. The method of claim 8, wherein the radionuclide comprises uranium.

15. The method of claim 8, wherein the microbial contaminant is a bacterium or a virus.

16. The method of claim 7, wherein the aqueous solution or the sparged solution has a pH between about 7 and about 12.

17. The method of claim 7, wherein the aqueous solution or the sparged solution has a pH between about 2 and about 7.

18-41. (canceled)

42. A method of removing a contaminant from a solution, which comprises:
adding to the solution a tunable chemical selected from the group consisting of N₂, H₂, alcohols, and carboxylic acids;
adjusting the pH of the solution so that it is greater than 9;
sparging the solution; and
irradiating the solution with ultraviolet light having a wavelength of less than 230 nm;
wherein:
the irradiation is performed during the sparging; and
the solution is an aqueous solution.

43. The method of claim 42, which further comprises adding a tunable chemical to the solution prior to irradiation, which tunable chemical is ethanol, isopropanol, or formic acid.

44. The method of claim 43, wherein a buffer is not used to maintain the pH of the solution.

45. The method of claim 44, wherein a sulfite is not added to the solution.

46. A method of removing a contaminant from a solution, which comprises:
adjusting the pH of the solution so that it is greater than 9;
sparging the solution with H₂; and
irradiating the solution with ultraviolet light having a wavelength of less than 230 nm;
wherein:
the irradiation is performed during the sparging; and
the solution is an aqueous solution.

47. The method of claim 46, which further comprises adding a tunable chemical to the solution prior to irradiation, which tunable chemical is ethanol, isopropanol, or formic acid.

48. The method of claim 47, wherein a buffer is not used to maintain the pH of the solution.

49. The method of claim 48, wherein a sulfite is not added to the solution.
